(19) United States
(12) Patent Application Publication
(10) Pub. No.: US 2023/0018553 A1
(43) Pub. Date: Jan. 19, 2023

(54) Processing Apparatus, Program, And Method

(71) Applicant: GungHo Online Entertainment, Inc., Tokyo (JP)

(72) Inventor: Kazuki MORISHITA, Tokyo (JP)

(21) Appl. No.: 17/882,720

(22) Filed: Aug. 8, 2022

Related U.S. Application Data
(63) Continuation of application No. PCT/JP2021/026521, filed on Jul. 14, 2021.

(51) Int. Cl. A63F 13/5252; A63F 13/533; A63F 13/86

(52) U.S. Cl. CPC A63F 13/5252; A63F 13/533; A63F 13/86

(57) ABSTRACT

A processing apparatus includes an input interface, an output interface, a memory, and a processor. The processor is configured to select one virtual camera from a plurality of virtual cameras arranged in a virtual game space in accordance with an instruction input from a spectator user accepted via the input interface while outputting a first spectacular image of the virtual game space virtually captured by another virtual camera via the output interface. The processor is configured to output a second spectacular image of the virtual game space virtually captured by one virtual camera via the output interface, instead of the first spectacular image.

### CROSS-REFERENCE TO RELATED APPLICATIONS

The present application is a continuation application of International Application No. PCT/JP2021/026521, filed on Jul. 14, 2021, which is expressly incorporated herein by reference in its entirety.

### BACKGROUND

### 1. Technical Field

The present disclosure relates to a processing apparatus, a program, and a method that enable output of a spectacular image of a virtual game space virtually captured by a virtual camera.

### 2. Related Art

Conventionally, known has been a system that displays a virtual game progressing due to a participant user in a virtual game space, visibly and audibly to a third party. For example, Japanese Patent Publication No. H11-244531 A discloses a system including a relay apparatus connected to a plurality of game apparatuses, in which the relay apparatus displays a live screen for a multiplayer game, so that a third party who is not participating in the game can watch the multiplayer game through the live screen.

### SUMMARY

In consideration of such techniques as above, an object of the present disclosure is to provide a processing apparatus, a program, and a method that enable provision of a more highly elaborate spectacular image to a spectator.

According to one aspect of the present disclosure, provided is “a processing apparatus including: an input interface configured to accept, in a virtual game that a participant user controls in progress, an instruction input from a spectator user different from the participant user, for selection of at least one desired virtual camera from a plurality of virtual cameras arranged in a virtual game space in which the virtual game progresses; an output interface configured to output, to the spectator user, a spectacular image of the virtual game space virtually captured by at least one virtual camera of the plurality of virtual cameras; a memory configured to store, in addition to a predetermined instruction command, an arrangement position of each virtual camera in the virtual game space and the spectacular image of the virtual game space; and a processor configured to perform control, based on the predetermined instruction command, such that a second virtual camera is selected from the plurality of virtual cameras in accordance with an instruction input from the spectator user accepted by the input interface when a first spectacular image of the virtual game space virtually captured by a first virtual camera in the plurality of virtual cameras remains output through the output interface and a second spectacular image of the virtual game space virtually captured by the second virtual camera is output from the output interface, instead of the first spectacular image virtually captured by the first virtual camera”.

According to one aspect of the present disclosure, provided is “a program for causing a computer including: an input interface configured to accept, in a virtual game that a participant user controls in progress, an instruction input from a spectator user different from the participant user, for selection of at least one desired virtual camera from a plurality of virtual cameras arranged in a virtual game space in which the virtual game progresses; an output interface configured to output, to the spectator user, a spectacular image of the virtual game space virtually captured by at least one virtual camera of the plurality of virtual cameras; and a memory configured to store an arrangement position of each virtual camera in the virtual game space and the spectacular image of the virtual game space, to function as a processor configured to select a second virtual camera from the plurality of virtual cameras in accordance with an instruction input from the spectator user accepted by the input interface when a first spectacular image of the virtual game space virtually captured by a first virtual camera in the plurality of virtual cameras remains output through the output interface and output a second spectacular image of the virtual game space virtually captured by the second virtual camera from the output interface, instead of the first spectacular image virtually captured by the first virtual camera”.

According to one aspect of the present disclosure, provided is “a method to be performed, in a computer including: an input interface configured to accept, in a virtual game that a participant user controls in progress, an instruction input from a spectator user different from the participant user, for selection of at least one desired virtual camera from a plurality of virtual cameras arranged in a virtual game space in which the virtual game progresses; an output interface configured to output, to the spectator user, a spectacular image of the virtual game space virtually captured by at least one virtual camera of the plurality of virtual cameras; and a memory configured to store, in addition to a predetermined instruction command, an arrangement position of each virtual camera in the virtual game space and the spectacular image of the virtual game space, due to execution of the predetermined instruction command by a processor, the method comprising: selecting a second virtual camera from the plurality of virtual cameras in accordance with an instruction input from the spectator user accepted by the input interface when a first spectacular image of the virtual game space virtually captured by a first virtual camera in the plurality of virtual cameras remains output through the output interface; and outputting a second spectacular image of the virtual game space virtually captured by the second virtual camera from the output interface, instead of the first spectacular image virtually captured by the first virtual camera”.

According to an embodiment of the present disclosure, provided can be a processing apparatus, a program, and a method that enable provision of a more highly elaborate spectacular image to a spectator.

Note that the effect is just exemplary for convenience of description and thus is not limiting. In addition to the effect or instead of the effect, any effect in the present disclosure or any effect obvious to a person skilled in the art can be achieved.

### BRIEF DESCRIPTION OF THE DRAWINGS

FIG. 1 is a diagram conceptually illustrating a virtual game space 10 for a virtual game according to an embodiment of the present disclosure.

FIG. 2 is a conceptual diagram of a schematic configuration of a system 1 according to the embodiment of the present disclosure.

FIG. 3A is a block diagram of an exemplary configuration of a terminal apparatus 100 according to the embodiment of the present disclosure. Further, FIG. 3B is a block diagram of an exemplary configuration of a server apparatus 200 according to the embodiment of the present disclosure.

FIG. 4A a diagram conceptually illustrating a user table stored in the server apparatus 200 according to the embodiment of the present disclosure. Further, FIG. 4B a diagram conceptually illustrating a virtual camera table stored in the terminal apparatus 100 according to the embodiment of the present disclosure. In addition, FIG. 4C is a diagram conceptually illustrating a character table stored in the terminal apparatus 100 according to the embodiment of the present disclosure.

FIG. 5 illustrates a processing sequence to be performed between the terminal apparatus 100 and the server apparatus 200 according to the embodiment of the present disclosure.

FIG. 6 illustrates a processing flow to be performed in the terminal apparatus 100 according to the embodiment of the present disclosure.

FIG. 7A illustrates a processing flow to be performed in the terminal apparatus 100 according to the embodiment of the present disclosure. Further, FIG. 7B illustrates a processing flow to be performed in the terminal apparatus 100 according to the embodiment of the present disclosure.

FIG. 8A illustrates a processing flow to be performed in the terminal apparatus 100 according to the embodiment of the present disclosure. Further, FIG. 8B illustrates a processing flow to be performed in the terminal apparatus 100 according to the embodiment of the present disclosure.

FIG. 9 is a diagram conceptually illustrating the virtual game space 10 for the virtual game according to the embodiment of the present disclosure.

FIG. 10 illustrates an exemplary image output on the terminal apparatus 100 according to the embodiment of the present disclosure.

FIG. 11 illustrates an exemplary image output on the terminal apparatus 100 according to the embodiment of the present disclosure.

FIG. 12A illustrates an exemplary image output on the terminal apparatus 100 according to the embodiment of the present disclosure. Further, FIG. 12B illustrates an exemplary image output on the terminal apparatus 100 according to the embodiment of the present disclosure.

FIG. 13 is a diagram conceptually illustrating the virtual game space 10 for the virtual game according to the embodiment of the present disclosure.

FIG. 14 illustrates an exemplary image output on the terminal apparatus 100 according to the embodiment of the present disclosure.

FIG. 15 illustrates an exemplary image output on the terminal apparatus 100 according to the embodiment of the present disclosure.

FIG. 16 is a diagram conceptually illustrating the virtual game space 10 for the virtual game according to the embodiment of the present disclosure.

FIG. 17 illustrates an exemplary image output on the terminal apparatus 100 according to the embodiment of the present disclosure.

FIG. 18 illustrates an exemplary image output on the terminal apparatus 100 according to the embodiment of the present disclosure.

### DESCRIPTION OF EXEMPLARY EMBODIMENTS

An embodiment of the present disclosure will be described with reference to the accompanying drawings. Note that the same constituent elements in the drawings are denoted with the same reference signs.

### 1. Outline of Application According to Present Disclosure

A virtual game according to the embodiment of the present disclosure is executed as a game application, for example, in a terminal apparatus. Then, at least one user participates as a participant in the virtual game, so that the at least one participant user can control the progress thereof. In addition to this, at least one user as a spectator can watch the virtual game progressing due to the at least one participant user.

A typical example of such a virtual game is a fighting game enabling fighting with a character as a virtual object that at least one user or a computer possesses. However, a system according to the present disclosure is not limited to this, and thus can be suitably applied to various virtual games, such as sports games, racing games, puzzle games, combat games, and role-playing games.

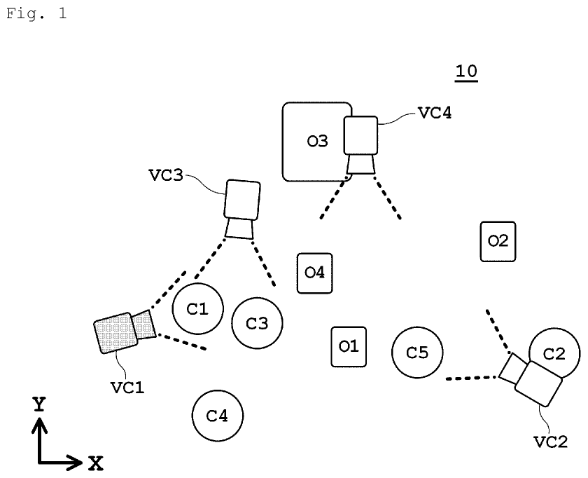

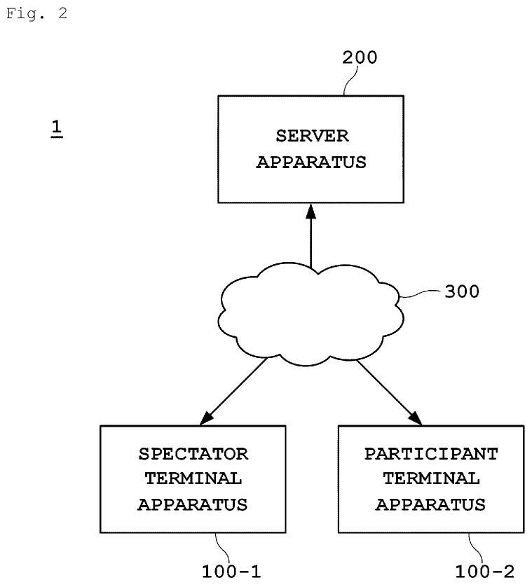

FIG. 1 conceptually illustrates a virtual game space 10 for the virtual game according to the embodiment of the present disclosure. Referring to FIG. 1, the virtual game space 10 expands from the predetermined origin in the X-axis direction and in the Y-axis direction. Note that, for convenience of description, FIG. 1 illustrates the virtual game space 10 as a two-dimensional coordinate space. However, in the following description, the virtual game space 10 will be given as a three-dimensional coordinate space. The virtual game space 10 is not limited to a particular coordinate space, such as a two-dimensional coordinate space or a three-dimensional coordinate space.

In the virtual game space 10, at predetermined arrangement positions, arranged are a character C1 as a virtual object to be controlled on the basis of an instruction input from a first participant user, a character C2 as a virtual object to be controlled on the basis of an instruction input from a second participant user, characters C3, C4, and C5 as virtual objects each to be controlled on the basis of an instruction input from another participant user or a computer, and structure objects O1 to O4 as virtual objects that are part of the virtual game space 10. In the virtual game space 10, in order to enable a spectator user to watch the progressing virtual game, arranged are a virtual camera VC1 that virtually captures a play scene of the character C1 as the character of the first participant user, a virtual camera VC2 that virtually captures a viewpoint image of the character C2 as the character of the second participant user, a virtual camera VC3 that virtually captures a combat scene in the virtual game space 10, and a virtual camera VC4 associated with the structure object O3. The image virtually captured by the virtual camera VC2 can be output as a play image on the terminal apparatus of the second participant user. The arrangement position of the virtual camera VC1 moves in accordance with movement of the character C1 associated with the virtual camera VC1 in the virtual game space 10, and the arrangement position of the virtual camera VC2 moves in accordance with movement of the character C2 associated with the virtual camera VC2 in the virtual game space 10. The virtual camera VC3 may be arranged fixedly in an area designated in advance as an area in which an event is more likely to occur (e.g., a combat scene between characters) or may detect the area in which an event remains performed in the virtual game and move in accordance with the area. Although only the virtual camera VC1 that captures a play scene of the character C1 is illustrated in FIG. 1, respective virtual cameras that capture play scenes of the characters C2 to C5 are arranged in addition. Although not illustrated in FIG. 1, a virtual camera that virtually captures a bird's-eye view image of the entirety of the virtual game space 10 is arranged.

Note that, in the present disclosure, an image that is displayed on the terminal apparatus of a participant user who participates as a player is referred to as a play image, and an image that is displayed on the terminal apparatus of a spectator user as a spectator is referred to as a spectacular image. However, the play image and the spectacular image are just given in order to distinguish the images. That is, it does not mean that the play image is viewable to only the participant user and the spectacular image is viewable to only the spectator user. The player image is viewable to any user other than the participant user, and the spectacular image is viewable to any user other than the spectator user.

In the present disclosure, virtually acquiring an image by each virtual camera is referred to as “capturing” or “shooting”. However, this does not mean actual capturing/shooting, for example, with a camera with which a terminal apparatus is equipped but means virtually capturing/shooting the virtual game space 10.

In the present disclosure, an image virtually captured by a virtual camera is simply referred to as an “image”. That is, unless otherwise noted, the “image” can include a still image and a moving image. In some cases, the “image” means the image, itself, virtually captured by the virtual camera or means a resultant image after the captured image is subjected to various types of processing/adjustment, for example, for output. That is, being simply referred to as an image can include such meanings.

In the present disclosure, each object, such as the characters, and virtual cameras are capable of moving in the virtual game space 10. Note that, the “movement” means just a variation in the relative positional relationship therebetween, and thus specific arrangement coordinates does not necessarily change. For example, in a case where the character C1 is controlled to move closer to the character C3 in the virtual game space 10, the arrangement coordinates of the character C1 may be updated to arrangement coordinates close to the character C3. Alternatively, with the arrangement coordinates of the character C1 defined as the origin, the arrangement coordinates of the character C3 may be updated to arrangement coordinates close to the character C1.

In the present disclosure, as exemplary users, a participant user and a spectator user are given. However, a user who intends to select the participant mode or a user who has selected the participant mode is just referred to as a participant user, and a user who intends to select the spectator mode or a user who has selected the spectator mode is just referred to as a spectator user. That is, even the same user can become either a spectator user or a participant user, in accordance with mode selection. Similarly, as exemplary terminal apparatuses, a participant terminal apparatus and a spectator terminal apparatus are given. However, the terminal apparatus that the participant user retains is just referred to as a participant terminal apparatus, and the terminal apparatus that the spectator user retains is just referred to as a spectator terminal apparatus. That is, even the same terminal apparatus can become either a participant terminal apparatus or a spectator terminal apparatus, in accordance with mode selection.

In the present disclosure, the virtual game progresses due to execution of the game application and includes at least one unit game that means an aggregate in the virtual game (e.g., at least one quest, at least one scenario, at least one chapter, at least one dungeon, at least one mission, at least one combat, at least one fight, at least one battle, or at least one stage). The virtual game may include a single unit game or may include a plurality of unit games.

In the present disclosure, “event” is a generic term for events that occur in the virtual game. Examples of such events include various events such as combat between characters, character evolution, acquisition of a particular item, a rise in the level of a participant user, clearing a quest or scenario, and conversation between characters.

In the present disclosure, a processing apparatus includes a terminal apparatus and a server apparatus. That is, the terminal apparatus and the server apparatus can each perform each piece of processing according to the embodiment below.

### 2. Configuration of System 1 According to Embodiment of Present Disclosure

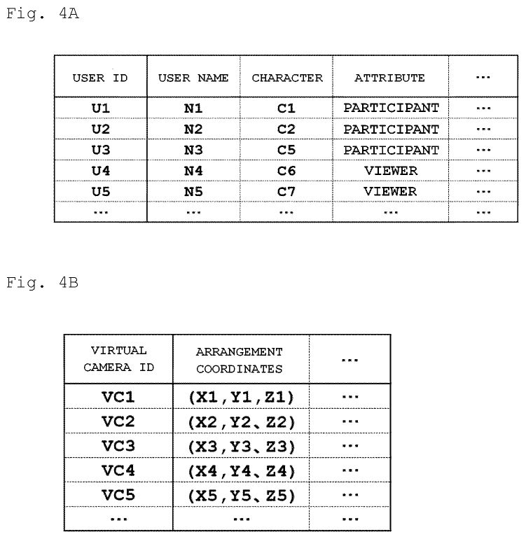

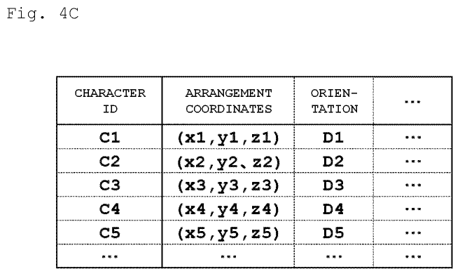

FIG. 2 is a conceptual diagram of a schematic configuration of a system 1 according to the embodiment of the present disclosure. Referring to FIG. 2, the system 1 includes a spectator terminal apparatus 100-1 available to a user as a spectator, a participant terminal apparatus 100-2 available to a user as a participant, and a server apparatus 200 connected communicably through a network 300. Note that, in some cases, terminal apparatuses including the spectator terminal apparatus 100-1 and the participant terminal apparatus 100-2, are each referred to as a terminal apparatus 100. In the system 1, the server apparatus 200 and the terminal apparatuses 100 each execute a program stored in a memory, resulting in execution of the game application according to the present embodiment. The server apparatus 200 and each terminal apparatus 100 have mutual communication anytime, so that transmission and reception of various types of information necessary for progress of the game application (e.g., refer to FIGS. 4A, 4B, and 4C) or a program is performed.

Note that, although only two terminal apparatuses 100 are provided in the example of FIG. 2, needless to say, three terminal apparatuses 100 or more can be provided in total. That is, the system 1 can include not only the single spectator terminal apparatus 100-1 but also a plurality of spectator terminal apparatuses in total. Similarly, the system 1 can include not only the single participant terminal apparatus 100-2 but also a plurality of participant terminal apparatuses in total.

Although the single server apparatus 200 is provided, the constituent elements and processing in the server apparatus 200 can be divided between a plurality of server apparatuses or a plurality of cloud server apparatuses. Furthermore, although the game application according to the present embodiment is executed by the system 1 including the server apparatus 200 and the terminal apparatuses 100, the game application can be executed by only the terminal apparatuses 100 without the server apparatus 200.

### 3. Configuration of Terminal Apparatus 100

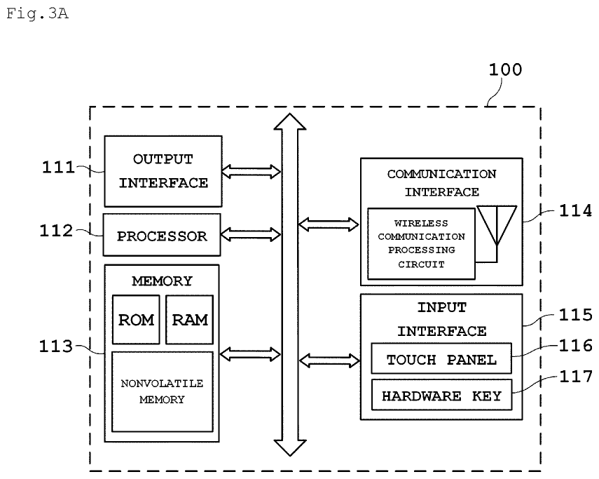

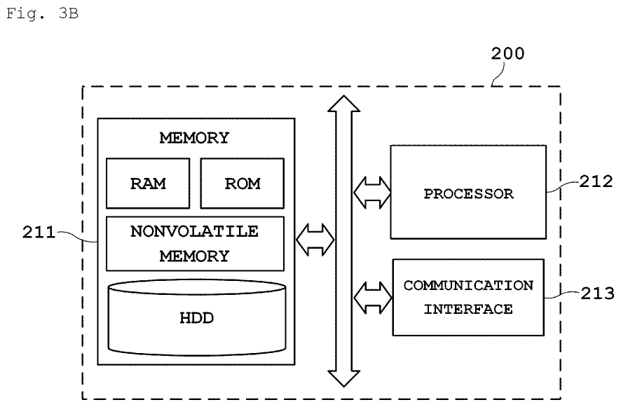

FIG. 3A is a block diagram of an exemplary configuration of a terminal apparatus 100 according to the embodiment of the present disclosure. The terminal apparatus 100 does not necessarily include all constituent elements illustrated in FIG. 3A and thus can omit part of the constituent elements. Alternatively, the terminal apparatus 100 can further include another constituent element.

An example of the terminal apparatus 100 is a stationary game console. In addition, the invention according to the disclosure can be suitably applied to any apparatus capable of executing the game application according to the present disclosure, such as a portable terminal apparatus that is typified by a smartphone and is capable of wireless communication, a portable game console, a feature phone, a portable information terminal, a personal digital assistant (PDA), a laptop personal computer, and a desktop personal computer. The terminal apparatuses, such as the spectator terminal apparatus 100-1 and the participant terminal apparatus 100-2, are not necessarily the same or identical in type. For example, the spectator terminal apparatus 100-1 may be a stationary game console, and the participant terminal apparatus 100-2 may be a portable game console.

Referring to FIG. 3A, the terminal apparatus 100 includes an output interface 111, a processor 112, a memory 113 including a random access memory (RAM), a read only memory (ROM), and a nonvolatile memory (if necessary, a hard disk drive (HDD)), a communication interface 114 including a communication processing circuit and an antenna, and an input interface 115 including a touch panel 116 and a hardware key 117. Then, the constituent elements are mutually electrically connected through a control line and a data line.

The processor 112 achieved by a central processing unit (CPU) (microcomputer) functions as a control unit that controls, on the basis of various types of programs stored in the memory 113, the connected other constituent elements. Specifically, the processor 112 reads, from the memory 113, a program for executing the game application according to the virtual game or a program for executing an operating system (OS), and executes the program. In the present embodiment, the processor 112 performs, for example, processing of selecting a second virtual camera (e.g., the virtual camera VC4 in FIG. 1) from a plurality of virtual cameras in accordance with an instruction input from the user accepted by the input interface 115 when a first spectacular image of the virtual game space virtually captured by a first virtual camera (e.g., the virtual camera VC1 in FIG. 1) in the plurality of virtual cameras remains output through the output interface 111, processing of outputting a second spectacular image of the virtual game space virtually captured by the second virtual camera (e.g., the virtual camera VC4 in FIG. 1) from the output interface 111, instead of the first spectacular image virtually captured by the first virtual camera (e.g., the virtual camera VC1 in FIG. 1), and processing of changing a parameter for the virtual camera that captures a spectacular image to be output from the output interface 111, on the basis of an instruction input from the spectator user accepted by the input interface 115. Note that the processor 112 may be achieved by a single CPU or may be achieved by a plurality of CPUs. For the processor 112, a different type of processor, such as a graphics processing unit (GPU) tailored for image processing, may be appropriately combined. The pieces of processing are not necessarily performed in each terminal apparatus 100, and thus only part of the pieces of processing may be performed in accordance with the situation of the user, such as a participant or a spectator.

The memory 113 including the ROM, the RAM, the nonvolatile memory, and the HDD, functions as a storage unit. The ROM stores, as programs, an instruction command for executing the game application according to the present embodiment and an instruction command for executing the OS. The RAM serves as a memory for use in data write and data read while the processor 112 is processing a program stored in the ROM. The nonvolatile memory serves as a memory to which data write and data read are performed due to execution of the program, and the written data remains saved even after the execution of the program terminates. In the present embodiment, the memory 113 stores game information necessary for execution of the game application (e.g., a virtual camera table in FIG. 4B and a character table in FIG. 4C). The memory 113 stores a program for, for example, processing of selecting the second virtual camera (e.g., the virtual camera VC4 in FIG. 1) from the plurality of virtual cameras in accordance with an instruction input from the user accepted by the input interface 115 when the first spectacular image of the virtual game space virtually captured by the first virtual camera (e.g., the virtual camera VC1 in FIG. 1) in the plurality of virtual cameras remains output through the output interface 111, processing of outputting the second spectacular image of the virtual game space virtually captured by the second virtual camera (e.g., the virtual camera VC4 in FIG. 1) from the output interface 111, instead of the first spectacular image virtually captured by the first virtual camera (e.g., the virtual camera VC1 in FIG. 1), and processing of changing a parameter for the virtual camera that captures a spectacular image to be output from the output interface 111, on the basis of an instruction input from the spectator user accepted by the input interface 115. Note that, although not particularly illustrated as the memory 113, for example, a removable storage medium or a database may be connected through the input interface 115. The program for the pieces of processing is not necessarily stored in each terminal apparatus 100, and thus only part of the program may be stored in accordance with the situation of the user, such as a participant or a spectator.

The communication interface 114 functions as a communication unit that performs, through the communication processing circuit and the antenna, transmission and reception of information with the server apparatus 200 or another terminal apparatus installed distantly. The communication processing circuit performs processing of receiving, from the server apparatus 200, the program for executing the game application according to the present embodiment or various types of information for use in the game application, in accordance with the progress of the game application. The communication processing circuit performs processing of transmitting, to the server apparatus 200, a result of processing due to execution of the game application.

The communication processing circuit is based on a wide-band wireless communication scheme typified by a long-term evolution (LTE) scheme in terms of processing, but can be based on a narrow-band wireless communication scheme, such as a wireless local area network (LAN) typified by IEEE 802.11 or Bluetooth (registered trademark), in terms of processing. Instead of wireless communication or in addition to wireless communication, wired communication can be used.

The input interface 115 including the touch panel 116 and/or the hardware key 117 functions as an input unit that accepts an instruction input from the user according to execution of the game application. The touch panel 116 is arranged covering a display as the output interface 111 and outputs, to the processor 112, information on the arrangement coordinates corresponding to image data that the display displays. As a touch panel technique, a publicly known technique is available, such as a resistive membrane technique, a capacitive coupling technique, or a surface acoustic wave technique with ultrasonic waves. Note that, because the touch panel 116 is an exemplary input interface, needless to say, a different input interface can be used instead. The communication interface 114 that connects with a controller or a keyboard connectable to the terminal apparatus 100 by wireless or by wire can function as the input interface 115 that accepts an instruction input from the user through the controller or the keyboard.

The output interface 111 functions as an output unit that reads, in accordance with an instruction from the processor 112, image information stored in the memory 113 and outputs various types of displays generated due to execution of the game application according to the present embodiment (e.g., refer to FIGS. 10, 11, 12A, 12B, 14, 15, 17, and 18). Examples of the output interface 111 include a liquid crystal display and an organic electroluminescent (EL) display. However, the terminal apparatus 100 itself is not necessarily equipped with a display. For example, the communication interface 114 that connects with a display connectable to the terminal apparatus 100 by wireless or by wire can function as the output interface 111 that outputs display data to the display.

### 4. Configuration of Server Apparatus 200

FIG. 3B is a block diagram of an exemplary configuration of the server apparatus 200 according to the embodiment of the present disclosure. The server apparatus 200 does not necessarily include all constituent elements illustrated in FIG. 3B, and thus can omit part of the constituent elements. Alternatively, the server apparatus 200 can further include another constituent element.

Referring to FIG. 3B, the server apparatus 200 includes a memory 211 including a RAM, a ROM, a nonvolatile memory, and an HDD, a processor 212 achieved by a CPU, and a communication interface 213. Then, the constituent elements are mutually electrically connected through a control line and a data line.

The memory 211 including the RAM, the ROM, the nonvolatile memory, and the HDD, functions as a storage unit. The memory 211 stores, as programs, an instruction command for executing the game application according to the present embodiment and an instruction command for executing the OS. Such a program is loaded and executed by the processor 212. The memory 211 (particularly, the RAM) is temporarily used for execution of data write and data read during execution of the program by the processor 212. The memory 211 stores, in addition to a user table illustrated in FIG. 4A, information on each item object to be arranged in the virtual game space formed due to execution of the game application and rendering information thereon. Furthermore, the memory 211 stores a program for performing, for example, processing of updating the user table in accordance with reception of mode information selected by the user from each terminal apparatus 100 through the communication interface 213, processing of updating various types of game information, such as the user table, in accordance with reception of operation information on the user from each terminal apparatus 100 through the communication interface 213, processing of transmitting updated game information to each terminal apparatus 100 through the communication interface 213, processing of receiving image information (e.g., a spectacular image) from each user through the communication interface 213 and storing the image information into the memory 211, and processing of distributing, to the other users, the image information stored the memory 211 through the communication interface 213.

The processor 212 achieved by the CPU (microcomputer) functions as a control unit that controls, on the basis of various types of programs stored in the memory 211, the connected other constituent elements. In the present embodiment, particularly, the processor 212 performs, for example, processing of updating the user table in accordance with reception of mode information selected by the user from each terminal apparatus 100 through the communication interface 213, processing of updating various types of game information, such as the user table, in accordance with reception of operation information on the user from each terminal apparatus 100 through the communication interface 213, processing of transmitting updated game information to each terminal apparatus 100 through the communication interface 213, processing of receiving image information (e.g., a spectacular image) from each user through the communication interface 213 and storing the image information into the memory 211, and processing of distributing, to the other users, the image information stored in the memory 211 through the communication interface 213. The processor 212 may be achieved by a single CPU or may be achieved by a plurality of CPUs.

As an example, the communication interface 213 performs processing, such as modulation and demodulation, for transmission and reception of the program for executing the game application according to the present embodiment and various types of information, with each terminal apparatus 100 through the network 300 or with another server apparatus through the network 300. The communication interface 213 communicates with each terminal apparatus or the another server apparatus, in accordance with the wireless communication scheme described above or a publicly known wired communication scheme.

5. Information that Each Memory Stores

FIG. 4A conceptually illustrates the user table stored in the server apparatus 200 according to the embodiment of the present disclosure. Information stored in the user table includes user ID information newly generated every time a user who uses the game application is newly registered, and is updated anytime in accordance with the progress of the game application.

Referring to FIG. 4A, in the user table, for example, user name information, character information, and attribute information are stored in association with user ID information. The “user ID information” is unique to each user and serves as information for specifying each user. The “user name information” serves as information for specifying a name that each user uses in the game application. For example, when executing the game application for the first time, each user can set the information, arbitrarily. The “character information” serves as information for specifying a virtual object that is retained as a user character by each user in the game application and is involved in the progress of the virtual game, such as fighting. In association with the character information that specifies the character, various-parameters information (e.g., hit points) is stored in the character table (refer to FIG. 4C). The “attribute information” is information stored in accordance with a mode selected by each user in the progress of the virtual game. In the information, “spectator” is stored for a user who has selected the spectator mode, and “participant” is stored for a user who has selected the participant mode. Note that a spectator user watches the virtual game that a participant user controls in progress. A participant user practically controls the progress of the virtual game, namely, makes the character retained by the user fight against another character or performs selection/input on various virtual objects. Note that, although not particularly illustrated in FIG. 4A, various types of information, such as the level, stamina, and in-game currency of each user, may be stored in association with the corresponding user ID information.

FIG. 4B conceptually illustrates the virtual camera table stored in the terminal apparatus 100 according to the embodiment of the present disclosure. Information stored in the virtual camera table is updated anytime in accordance with the game information received from the server apparatus 200.

Referring to FIG. 4B, in the virtual camera table, arrangement coordinates information is stored in association with virtual camera ID information. The “virtual camera ID information” is unique to each virtual camera and serves as information for specifying each virtual camera. The “arrangement coordinates information” indicates the arrangement position of a virtual camera and serves as coordinates information in the X, Y, and Z directions in a three-dimensional coordinate space. Note that, although not particularly illustrated in FIG. 4B, as capturing parameters for each virtual camera, for example, orientation information indicating the current orientation of each virtual camera and zoom information indicating the scale of enlargement or reduction of an image that each virtual camera captures are stored in association with the virtual camera ID information. The capturing parameters may each have a previously determined set value, and are updated anytime in accordance with an instruction input from the user.

FIG. 4C conceptually illustrates the character table stored in the terminal apparatus 100 according to the embodiment of the present disclosure. Information stored in the character table is updated anytime in accordance with the game information received from the server apparatus 200 or an instruction input from the user accepted by the input interface 115.

Referring to FIG. 4C, in the character table, arrangement coordinates information and orientation information are stored in association with character ID information. The “character ID information” is unique to each character as a virtual object and serves as information for specifying each character. The “arrangement coordinates information” indicates the arrangement position of a character and serves as coordinates information in the X, Y, and Z directions in a three-dimensional coordinate space. The “orientation information” indicates the direction in which a character faces in the virtual game space. Specifically, stored is information indicating the direction in which a face object that is part of a character faces. Note that, although not particularly illustrated in FIG. 4C, various types of information (e.g., hit points, offensive power, defensive power, magic, items, and attribute) for use in fighting against another character, such as an enemy character, are stored in association with the character ID information.

### 6. Information to be Transmitted and Received Between Terminal Apparatus 100 and Server Apparatus 200

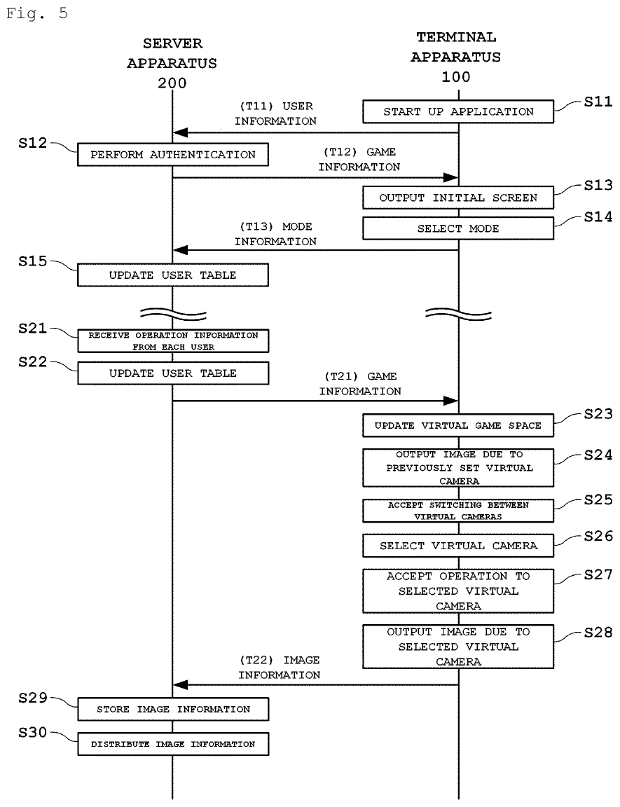

FIG. 5 illustrates a processing sequence to be performed between the terminal apparatus 100 and the server apparatus 200 according to the embodiment of the present disclosure. Specifically, the processing sequence in FIG. 5 is performed between the server apparatus 200 and the terminal apparatus 100 (spectator terminal apparatus 100-1 in the example of FIG. 5) through the network 300 during progress of a unit game due to execution of the game application.

First, described will be processing in which the user selects either participation in the virtual game as a participant user or participation in the virtual game as a spectator user. Referring to FIG. 5, when the input interface 115 of the terminal apparatus 100 accepts an instruction input from the user, the game application starts up, on the basis of the instruction input, in order to execute the virtual game (S11). Then, user information (T11) including the user ID information on the user of the terminal apparatus 100 is transmitted to the server apparatus 200 through the communication interface 114.

The server apparatus 200 having received the user information performs user authentication, on the basis of the received user ID information (S12), and transmits, when the user is authenticated as valid, various types of game information (T12) necessary for the game application to the terminal apparatus 100.

The terminal apparatus 100 having received the game information outputs an initial screen on the display (S13), and performs, for example, selection of a unit game to be executed or selection of a character to be used, on the basis of an instruction input from the user. Next, the terminal apparatus 100 performs display of a mode selection screen for selection of either the participant mode for participation in the virtual game as a participant user or the spectator mode for participation in the virtual game as a spectator user, and selects a desired mode, on the basis of an instruction input from the user (S14). Then, the terminal apparatus 100 transmits, to the server apparatus 200, the selected mode as mode information (T13) together with the user ID information (S14). Note that, in the following, given will be a case where the spectator mode for participation as a spectator user is selected by the user.

The server apparatus 200 having received the mode information stores the received mode information into the attribute information in the user table, on the basis of the user ID information (S15).

Next, given will be a case where, after mode selection, the virtual game progresses in the selected mode. Referring to FIG. 5, in accordance with the progress of the virtual game, the server apparatus 200 receives, for example, from the participant terminal apparatus 100-2 retained by a participant user, operation information accepted by the input interface 115 of the participant terminal apparatus 100-2 (S21). As an example, the operation information includes designation information, such as the direction of movement of the character of the participant user or activation of attack. Then, the server apparatus 200 updates and stores, for example, the user table with the received operation information. The server apparatus 200 transmits, to each terminal apparatus 100, game information (T21) necessary for progress of the virtual game, inclusive of the information updated in the user table (S22).

When receiving the game information, the terminal apparatus 100 updates and stores information, such as the virtual camera table and the character table, on the basis of the received game information (S23). Then, the terminal apparatus 100 forms the virtual game space 10, on the basis of the received information, and outputs, through the output interface 111, a spectacular image captured by a previously set virtual camera (S24). Next, for example, when the input interface 115 accepts an instruction input regarding switching between virtual cameras from the spectator user (S25), the terminal apparatus 100 performs selection of (switching to) a virtual camera, on the basis of the instruction input (S26).

Furthermore, when the input interface 115 accepts an instruction input regarding an operation to the virtual camera from the spectator user (S27), the terminal apparatus 100 performs processing of changing a parameter for the virtual camera on the basis of the instruction input. Then, the terminal apparatus 100 performs capturing of the virtual game space 10 with the virtual camera selected in S26, on the basis of the parameter changed in S27, and outputs the captured image as a spectacular image from the output interface 111 (S28).

Note that, in some cases, the captured spectacular image is distributed to, for example, any other spectator user. In such a case, the terminal apparatus 100 transmits image information (T22) including the spectacular image to the server apparatus 200 through the communication interface 114.

The server apparatus 200 having received the image information stores the received image information into the memory 211 (S29), and distributes the stored image information to, for example, the terminal apparatus of any other previously registered spectator user. Then, the processing sequence terminates. Note that a trigger for switching between virtual cameras in S25 corresponds to acceptance of an instruction input from the spectator user by the input interface 115. However, for example, a trigger for switching between virtual cameras may correspond to a variation in the order of each character or an event that occurs in the virtual game.

### 7. Processing Flow to be Performed in Terminal Apparatus 100

### (1) Processing According to Mode Selection

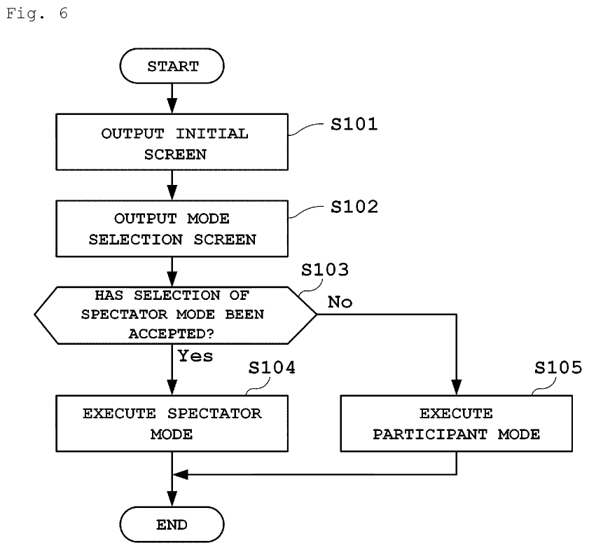

FIG. 6 illustrates a processing flow to be performed in the terminal apparatus 100 according to the embodiment of the present disclosure. Specifically, the processing flow in FIG. 6 is performed after reception of game information that follows authentication in the server apparatus 200 that follows start-up of the game application in the terminal apparatus 100 retained by the user. The processing flow is performed mainly when the processor 112 in the terminal apparatus 100 reads and executes a program stored in the memory 113.

Referring to FIG. 6, for example, on the basis of the game information received from the server apparatus 200, the processor 112 performs control such that the initial screen is output through the output interface 111 (S101). Next, when the input interface 115 accepts an instruction input from the user, the processor 112 performs, for example, selection of a unit game to be executed or selection of a character to be used, on the basis of the accepted instruction, and outputs the mode selection screen through the output interface 111 (S102).

Although not particularly illustrated, on the mode selection screen, displayed are a participant mode icon for selection of the participant mode and a spectator mode icon for selection of the spectator mode, in addition to a stage name (dungeon A) selected by the operator user. When the user selects the participant mode icon through the input interface 115, the virtual game progresses in the participant mode. When the user selects the spectator mode icon through the input interface 115, the virtual game progresses in the spectator mode.

Referring back to FIG. 6, when an instruction input from the user to the mode selection screen is accepted through the input interface 115, the processor 112 determines whether or not the spectator mode has been selected, on the basis of the instruction (S103). Then, in a case where the spectator mode has been selected, the processor 112 executes the virtual game in the spectator mode (S104). Meanwhile, in a case where the spectator mode has not been selected, the processor 112 executes the virtual game in the participant mode (S105). After that, although not particularly illustrated, the processor 112 transmits, for example, information regarding the selected mode to the server apparatus 200, and then terminates a flow of processing according to the mode selection.

### (2) Processing in Spectator Mode

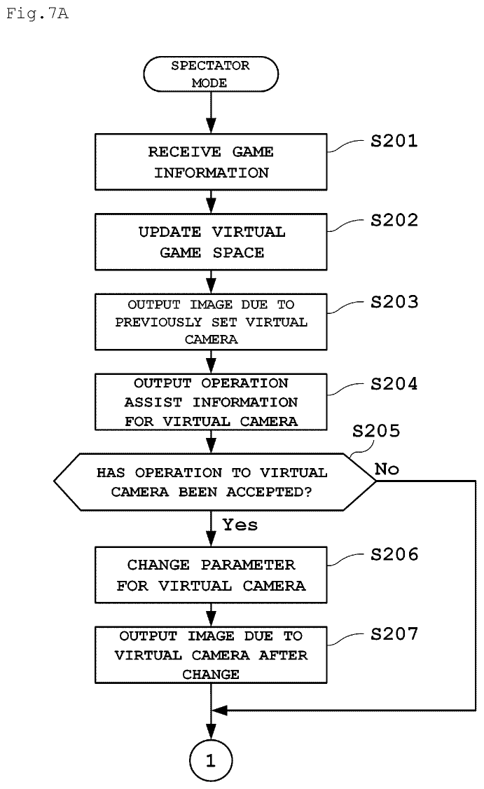

FIGS. 7A and 7B each illustrate a processing flow to be performed in the terminal apparatus 100 according to the embodiment of the present disclosure. Specifically, the processing flow in each of FIGS. 7A and 7B is performed during execution of the virtual game in the spectator mode in the terminal apparatus 100 retained by the user. The processing flow is performed mainly when the processor 112 in the terminal apparatus 100 reads and executes a program stored in the memory 113.

Referring to FIG. 7A, the processor 112 in the terminal apparatus 100 performs control with predetermined timing such that game information is received from the server apparatus 200 through the communication interface 114 (S201). The game information includes various types of information for use in the progress of the game. As an example, the game information includes operation information to the character of the participant user and the arrangement coordinates of the character, received from the participant terminal apparatus 100-2. The processor 112 updates and stores the character table with the received game information. On the basis of the received arrangement coordinates of the character, the processor 112 updates and stores the arrangement coordinates of a virtual camera capable of moving while following the character, in the virtual camera table.

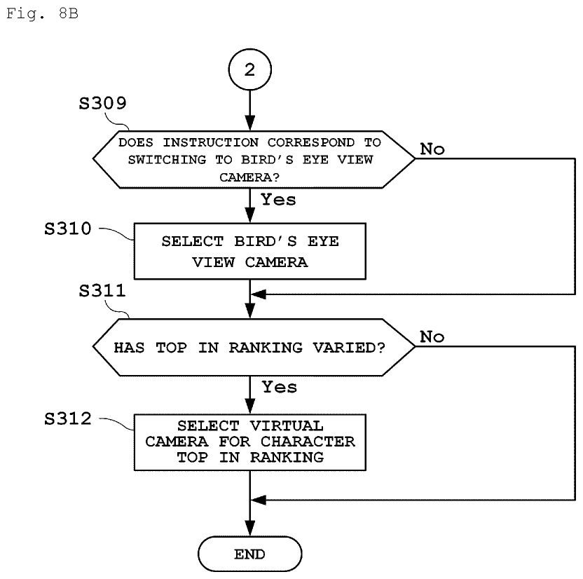

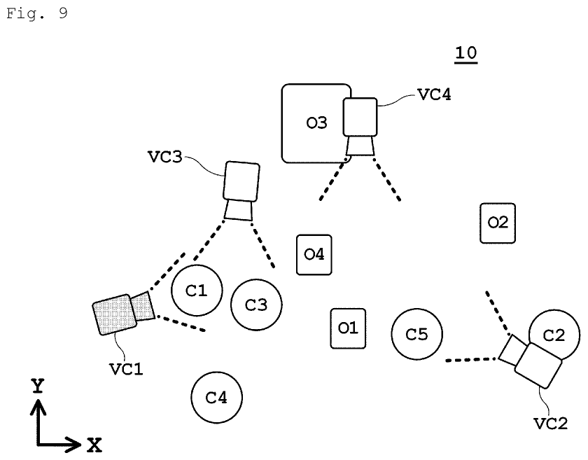

Next, for example, with the arrangement coordinates information in the updated character table, the processor 112 updates the respective positions of the characters and the objects arranged in the virtual game space 10. Here, FIG. 9 conceptually illustrates the virtual game space 10 for the virtual game according to the embodiment of the present disclosure. Specifically, FIG. 9 illustrates the virtual game space 10 updated in S202 of FIG. 7A. Note that, although the virtual game space 10 in FIG. 9 is given as a two-dimensional space for convenience of description, the virtual game space 10 is formed as a three-dimensional space.

Referring to FIG. 9, on the basis of the arrangement coordinates information on each virtual camera stored in the virtual camera table and the arrangement coordinates information on each character stored in the character table, each character and each virtual camera are arranged in the virtual game space 10. On the basis of the arrangement coordinates information on each structure object stored in an object table (not illustrated), each structure object is arranged in the virtual game space 10. Specifically, in the virtual game space 10, on the basis of each piece of arrangement coordinates information, arranged are the character C1 to be controlled on the basis of an instruction input from the first participant user, the character C2 to be controlled on the basis of an instruction input from the second participant user, the characters C3, C4, and C5 each to be controlled on the basis of an instruction input from another participant user or the computer, and the structure objects O1 to O4 that are part of the virtual game space 10. In the virtual game space 10, in order to enable a spectator user to watch the progressing virtual game, arranged are the virtual camera VC1 that virtually captures a play scene of the character C1 as the character of the first participant user, the virtual camera VC2 that virtually captures a viewpoint image of the character C2 as the character of the second participant user, the virtual camera VC3 that virtually captures a battel scene in the virtual game space 10, and the virtual camera VC4 associated with the structure object O3. The image virtually captured by the virtual camera VC2 can be output as a play image on the terminal apparatus of the second participant user. The arrangement position of the virtual camera VC1 moves in accordance with movement of the character C1 associated with the virtual camera VC1 in the virtual game space 10, and the arrangement position of the virtual camera VC2 moves in accordance with movement of the character C2 associated with the virtual camera VC2 in the virtual game space 10. The virtual camera VC3 may be arranged fixedly in an area designated in advance as an area in which an event is more likely to occur (e.g., a combat scene between characters) or may detect the area in which an event remains performed in the virtual game and move in accordance with the area. Although only the virtual camera VC1 that captures a play scene of the character C1 is illustrated in FIG. 1, respective virtual cameras that capture play scenes of the characters C2 to C5 are arranged in addition. Although not illustrated in FIG. 1, a virtual camera that virtually captures a bird's-eye view image of the entirety of the virtual game space 10 is arranged.

Note that, in the present embodiment, at a stage before a spectator user selects a desired virtual camera, the virtual camera (virtual camera VC1) that captures a play scene of the character of the participant user who is top in the current ranking in the virtual game (e.g., the character C1) is set in advance as the virtual camera that captures a spectacular image. Instead of this, the virtual camera that captures a play scene of the character of the participant user as host in the virtual game may be set in advance as the virtual camera that captures a spectacular image.

Referring back to FIG. 7A, the processor 112 virtually captures the virtual game space 10 with the previously set virtual camera VC1 (virtual camera that captures the character of the participant user who is top in the current ranking), generates a spectacular image, and stores the spectacular image into the memory 113. Then, the processor 112 performs control such that the stored spectacular image is output through the output interface 111 (S203). In this case, the processor 112 outputs operation assist information in superimposition on the output spectacular image (S204). The operation assist information indicates, for a character not included in the spectacular image because the character is out of the angle of view of the virtual camera VC1, the direction leading to the arrangement position of the character, to assist a change in the parameter regarding the orientation of the virtual camera VC1.

Here, FIG. 10 illustrates an exemplary image output on the terminal apparatus 100 according to the embodiment of the present disclosure. Specifically, FIG. 10 illustrates an exemplary spectacular image output on the display in S203 of FIG. 7A and exemplary operation assist information output in superimposition on the spectacular image on the display in S204. Referring to FIG. 10, illustrated is the spectacular image captured by the virtual camera VC1 associated with the character C1 of the participant user who is top in the current ranking. Thus, the back image of the character C1 is located substantially at the center of the spectacular image. In the virtual game space 10, the structure object O3, the structure object O4, the character C3, and the structure object O1 are arranged in order from the left end of the angle of view of the virtual camera VC1. Thus, the spectacular image includes, in order from its left end, the structure object O3, the structure object O4, the character C3, and the structure object O1. Note that, in the virtual game space 10, the character C2, the character C5, and the structure object O2 are included in the angle of view of the virtual camera VC1. However, the character C2, the character C5, and the structure object O2 are hidden on the back side of the character C3 and the structure objects O1 and O3 located closer to the virtual camera VC1, resulting in non-display. Although the virtual camera VC4 and the virtual camera VC2 are included in the angle of view of the virtual camera VC1, the virtual cameras are inhibited from being displayed in the spectacular image.

Referring to FIG. 10, operation assist information 12 is output in superimposition on the spectacular image. The operation assist information 12 that is a right arrow in shape, is output together with the letter “C4”. That is, the operation assist information 12 indicates that, although the character C4 is not included in the angle of view of the virtual camera VC1 because of its current orientation, if the orientation of the virtual camera VC1 is adjusted to the right, the character C4 is included in the angle of view. Thus, for example, when the spectator user wants to watch the character C4, the spectator user can be assisted in changing the orientation of the virtual camera VC1. Note that, although the operation assist information 12 is given as an arrow object, this is just exemplary. Thus, provided may be any form, such as text information or a figure different from any arrow. In the example of FIG. 10, although only the operation assist information 12 indicating the position of the character C4 is output, operation assist information indicating the position of another character or another virtual object may be further output. The number of pieces of operation assist information to be output simultaneously is not particularly limited.

Referring back to FIG. 7A, the processor 112 determines whether or not the input interface 115 has accepted an instruction input from the spectator user, in order to operate the parameter regarding the orientation of the virtual camera VC1 (S205). In response to reception of an interrupt signal due to acceptance of the instruction input by the input interface 115, the processor 112 changes the corresponding parameter for the virtual camera VC1, on the basis of the accepted instruction input. For example, in a case where an instruction input for changing the orientation of the virtual camera VC1 to the direction leading to the character C4 is accepted, the processor 112 changes the parameter regarding the orientation of the virtual camera VC1 and updates and stores the virtual camera table with the changed parameter. Then, the processor 112 captures the virtual game space 10 with the virtual camera VC1 changed in orientation. Then, the processor 112 stores the acquired image as a spectacular image into the memory 113, and additionally outputs the spectacular image on the display through the output interface 111.

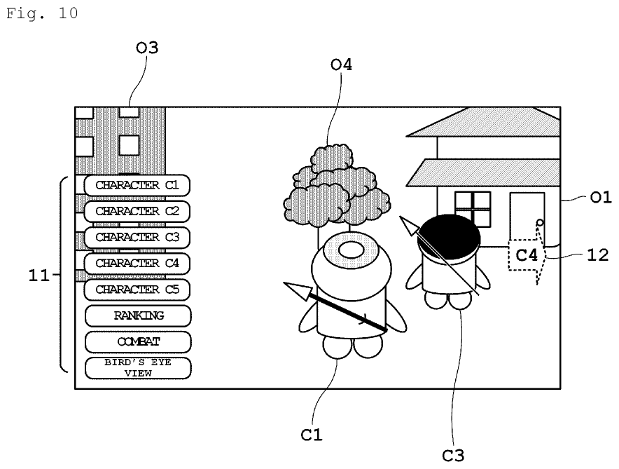

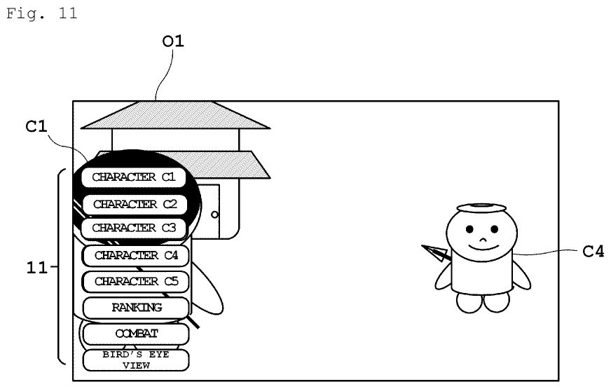

Here, FIG. 11 illustrates an exemplary image output on the terminal apparatus 100 according to the embodiment of the present disclosure. Specifically, FIG. 11 illustrates a spectacular image output in S207 after the parameter regarding the orientation of the virtual camera VC1 is changed in S206 of FIG. 7A. Referring to FIG. 11, the spectacular image includes the character C4 because the character C4 is included in the angle of view of the virtual camera VC1 facing in the direction leading to the character C4. On the other hand, because the virtual camera VC1 has changed in orientation in the virtual game space 10, the structure objects O3 and O4 are out of the angle of view thereof. Therefore, the spectacular image of FIG. 11 includes no structure objects O3 and O4.

Note that, with the processing flow of FIG. 7A and FIGS. 9 to 11, given has been the example in which the parameter regarding the orientation of the virtual camera VC1 as a parameter for the virtual camera VC1 is changed. Moreover, given has been the operation assist information 12 that assists a change in the orientation of the virtual camera VC1. However, this is not limiting, and thus another parameter for the virtual camera VC1 may be changed. For example, although a character is included in the angle of view, the character may be too small to recognize because the character is distant from the virtual camera. In such a case, near the character included in the spectacular image, information for specifying the character and the letter enlargement can be output as operation assist information. Thus, in order to increase the character in size for recognition, the spectator user changes a parameter regarding zooming of the virtual camera, so that a change can be made in the scale of enlargement or reduction of an image to be captured.

Next, referring to the processing flow of FIG. 7B, the processor 112 determines whether or not an interrupt signal for switching the virtual camera that captures a spectacular image from the virtual camera VC1 to another virtual camera has been accepted (S208). In a case where the interrupt signal has been accepted, the processor 112 selects a virtual camera newly as the virtual camera that captures a spectacular image, on the basis of the accepted switching instruction (S209). The processor 112 virtually captures the virtual game space 10 with the newly selected virtual camera, generates a spectacular image, and stores the spectacular image into the memory 113. Then, the processor 112 performs control such that the stored spectacular image is output through the output interface 111 (S210). In this case, similarly to S204 of FIG. 7A, the processor 112 outputs operation assist information for the newly selected virtual camera in superimposition on the spectacular image (S211). Note that the processing according to selection of a virtual camera in S208 and S209 will be described in detail below.

Next, the processor 112 determines whether or not the input interface 115 has accepted an instruction input from the spectator user, in order to operate a parameter regarding the orientation of the virtual camera VC4 newly selected (S212). In response to reception of an interrupt signal due to acceptance of the instruction input by the input interface 115, the processor 112 changes the corresponding parameter for the virtual camera VC4, on the basis of the accepted instruction input. For example, in a case where an instruction input for changing the orientation of the virtual camera VC4 to the direction leading to the character C2 is accepted, the processor 112 changes the parameter regarding the orientation of the virtual camera VC4 and updates and stores the virtual camera table with the changed parameter. Then, the processor 112 captures the virtual game space 10 with the virtual camera VC4 changed in orientation. Then, the processor 112 stores the acquired image as a spectacular image into the memory 113, and additionally outputs the spectacular image on the display through the output interface 111. Then, the processing flow in the spectator mode terminates.

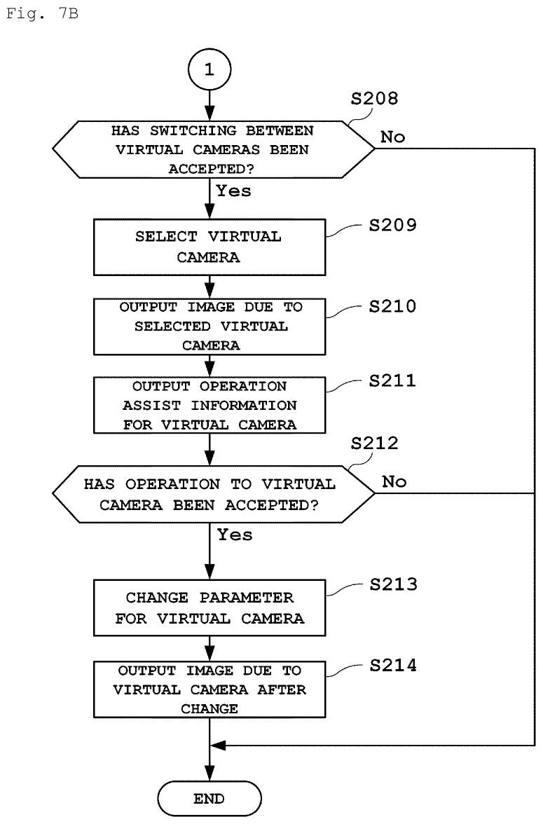

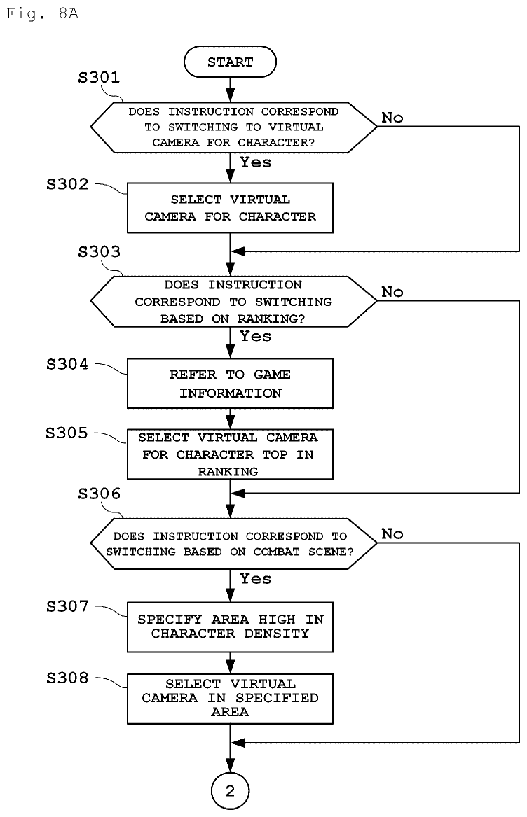

FIGS. 8A and 8B each illustrate a processing flow to be performed in the terminal apparatus 100 according to the embodiment of the present disclosure. Specifically, the processing flow in each of FIGS. 8A and 8B is involved in selection of a virtual camera to be performed in S208 and S209 of FIG. 7B. The processing flow is performed mainly when the processor 112 in the terminal apparatus 100 reads and executes a program stored in the memory 113.

Referring to FIG. 8A, the processing flow starts due to acceptance of an interrupt signal for switching from the virtual camera VC1 to another virtual camera. When the input interface 115 accepts an instruction input from the spectator user, on the basis of the instruction input, the processor determines whether or not the instruction corresponds to switching to the virtual camera that captures a play scene of any character (S301). Then, in a case where the determination results in “Yes” in S301, on the basis of the instruction input, the processor 112 selects the virtual camera for the character selected by the spectator user (S302), and outputs the image due to the virtual camera as a spectacular image.

In a case where the determination results in “No” in S301, on the basis of the instruction input from the spectator user, the processor 112 determines whether or not the instruction corresponds to switching to a virtual camera based on ranking (S303). In a case where the determination results in “Yes” in S303, the processor 112 refers to the current participant-users rankings based on the various types of game information stored in the memory 113 (S304). Then, the processor 112 selects the virtual camera that captures a play scene of the character of the participant user who is top in ranking (S305), and outputs the image due to the virtual camera as a spectacular image. Note that the ranking can be generated on the basis of various types of information, such as the numerical value of accumulated damage of the character of each participant user to the other characters, the numerical value of progress level in the virtual game of each participant user, and the numerical value of proficiency level in the virtual game of each participant user. The virtual camera that captures the character of the participant user who is top in ranking is not necessarily selected, and thus the virtual camera that captures the character of a participant user who is not top in ranking may be selected.

On the other hand, in a case where the determination results in “No” in S303, on the basis of the instruction input from the spectator user, the processor 112 determines whether or not the instruction corresponds to switching to a virtual camera based on an event (S306). As an example, the processor 112 determines whether or not the instruction corresponds to switching to a virtual camera based on a combat scene. In a case where the determination results in “Yes” in S306, the processor 112 specifies the area highest in character density in the virtual game space 10, with reference to the arrangement coordinates information in the character table (S307). An example of the area is a generated area from predetermined sized grids into which the virtual game space 10 is divided. Then, the processor 112 selects the virtual camera present in the specified area or the virtual camera nearest to the specified area (S308), and outputs the image due to the virtual camera as a spectacular image.

Note that, in selection of a virtual camera based on an event, selection of a virtual camera based on character density is just exemplary. For example, the processor 112 may select a virtual camera, on the basis of the arrangement state of the virtual objects, such as the structure objects, arranged in the virtual game space 10. Specifically, the processor 112 specifies, as an area in which an event is more likely to occur, the area in which a structure object (e.g., a structure object suitable for a character to hide) often used in combat scenes is arranged or the area in which a particular item object enabling an advantageous effect on any participant user or character is arranged, and selects the corresponding virtual camera. As another example, with an area in which an event is more likely to occur, specified in advance on the basis of the arrangement state of the virtual objects, the processor 112 may select, for selection of a virtual camera based on an event, the virtual camera fixedly arranged in advance in the area.

In a case where the determination results in “No” in S306, on the basis of the instruction input from the spectator user, the processor 112 determines whether or not the instruction corresponds to switching to the bird's eye view camera (S309). In a case where the determination results in “Yes” in S309, the processor 112 selects the virtual camera arranged above the virtual game space 10 for a bird's eye view of the virtual game space 10 (S310), and outputs the image due to the virtual camera as a spectacular image.

Here, from S301 to S310, acceptance of an instruction input from the spectator user by the input interface 115 corresponds to a trigger for switching between virtual cameras. In S311 and S312, instead of an instruction input from the spectator user, a variation in ranking serves as a trigger. In a case where the determination results in “No” in S309, with reference to the current participant-users rankings based on the various types of game information stored in the memory 113, the processor 112 determines whether or not the participant user who is top in ranking has varied (S311). In a case where the determination results in “Yes” in S311, the virtual camera that captures a play scene of the character of the participant user who is top in ranking is selected (S312), and the image due to the virtual camera is output as a spectacular image. Note that the ranking can be generated on the basis of various types of information, such as the numerical value of accumulated damage of the character of each participant user to the other characters, the numerical value of progress level in the virtual game of each participant user, and the numerical value of proficiency level in the virtual game of each participant user. Then, the processing flow terminates.

Referring back to FIG. 10, regarding switching between virtual cameras, selection assist information 11 that assists the spectator user in newly selecting a virtual camera is output in superimposition on the spectacular image captured by the previously set virtual camera VC1. Specifically, as the selection assist information 11, output are icons (character C1 icon to character C5 icon) for selection of the respective characters of the participant users who are participating as participants in the virtual game in execution, an icon (ranking icon) for selection of the character of the participant user who is top in the current ranking, an icon (combat icon) for selection of a scene of an event remaining performed, and an icon (bird's eye view icon) for selection of a bird's eye view image of the virtual game space 10 from above. In this state, when an instruction input for selection of any one of the icons is accepted through the input interface 115 (namely, any of S301, S303, and S306 of FIG. 8A and S309 of FIG. 8B), the processor 112 selects the virtual camera associated with the character corresponding to the selected icon.

Note that, in the example, when any one of the character icons is selected, the virtual camera that captures a play scene of the corresponding character is selected. However, such a method of selecting a virtual camera is just exemplary. For example, when any one of the character icons is selected from the selection assist information 11, the processor 112 extracts the arrangement coordinates and orientation of the character corresponding to the selected icon from the character table, and selects a virtual camera on the basis of the extracted arrangement coordinates and orientation of the character.

Specifically, the processor 112 extracts at least one virtual camera that can include the character in its angle of view, on the basis of the arrangement coordinates of the character. Next, in a case where a plurality of virtual cameras is extracted, the processor 112 further narrows the plurality of virtual cameras down to at least one virtual camera that can capture the character from in front, on the basis of the orientation of the character. Then, the processor 112 selects, as the virtual camera that captures a spectacular image, the nearest virtual camera from the narrowed virtual cameras.

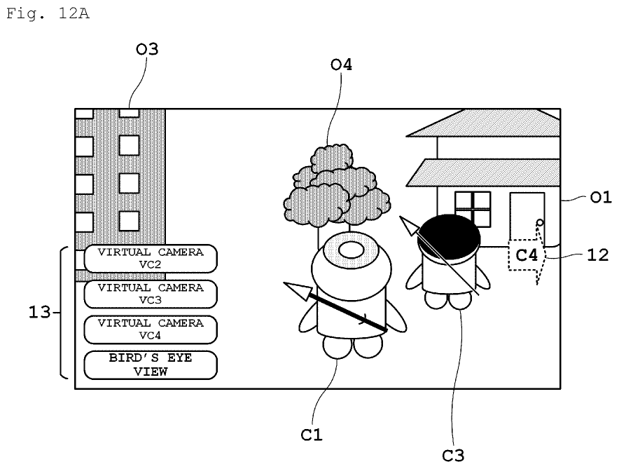

FIGS. 12A and 12B each illustrate an exemplary image output on the terminal apparatus 100 according to the embodiment of the present disclosure. Specifically, FIGS. 12A and 12B each illustrate other exemplary selection assist information that assists selection of a virtual camera. Referring to FIG. 12A, selection assist information 13 that assists selection of a virtual camera, is output in superimposition on the spectacular image captured by the virtual camera VC1 set as default. Specifically, together with information for specifying each virtual camera, icons each for selection of the corresponding virtual camera are output as the selection assist information 13. Due to acceptance of an instruction input for selection of the icon corresponding to a desired virtual camera from the spectator user, the processor 112 selects, as the virtual camera that captures a spectacular image, the virtual camera corresponding to the icon.

Referring to FIG. 12B, selection assist information 14 that assists selection of a virtual camera is output in superimposition on the spectacular image captured by the virtual camera VC1 set as default. Specifically, thumbnail images each generated due to capturing of the current virtual game space 10 by the corresponding virtual camera are output as the selection assist information 14. Due to acceptance of an instruction input for selection of the thumbnail image corresponding to a desired virtual camera from the spectator user referring to each output thumbnail image, the processor 112 selects, as the virtual camera that captures a spectacular image, the virtual camera corresponding to the thumbnail image. Use of such thumbnail images as selection assist information enables the spectator user to select a virtual camera more intuitively.

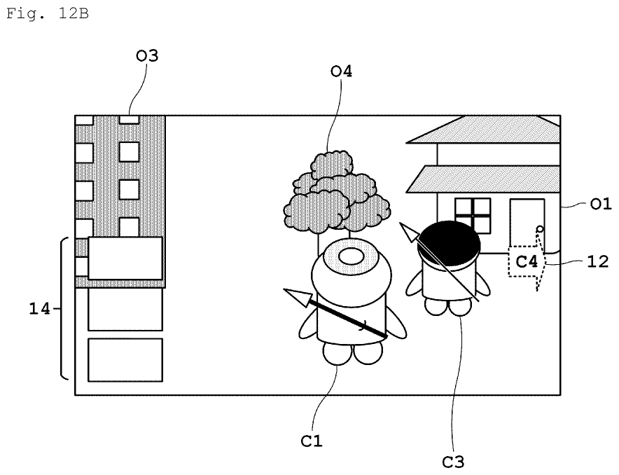

FIG. 13 conceptually illustrates the virtual game space 10 for the virtual game according to the embodiment of the present disclosure. Specifically, FIG. 13 illustrates the virtual game space 10 after a virtual camera is newly selected in S209 of FIG. 8. Note that, although the virtual game space 10 in FIG. 13 is given as a two-dimensional space for convenience of description, the virtual game space 10 is formed as a three-dimensional space.

Referring to FIG. 13, similarly to FIG. 9, on the basis of the arrangement coordinates information on each virtual camera stored in the virtual camera table and the arrangement coordinates information on each character stored in the character table, each character and each virtual camera are arranged in the virtual game space 10. In this state, the virtual camera VC4 remains selected due to acceptance of an instruction input for switching the virtual camera that captures a spectacular image from the virtual camera VC1 to the virtual camera VC4 (S209 of FIG. 8). Thus, the captured image of the virtual game space 10 by the virtual camera VC4 is output as a spectacular image.

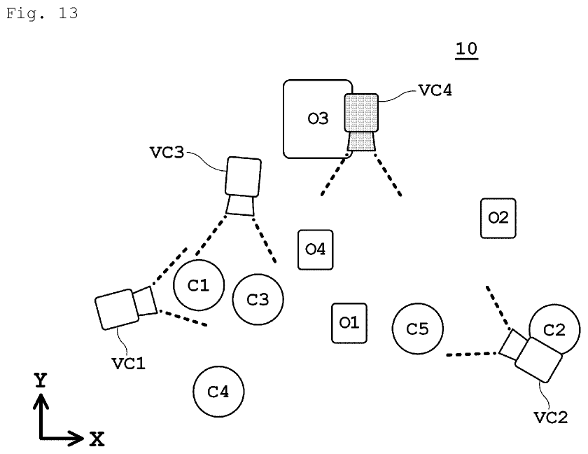

FIG. 14 illustrates an exemplary image output on the terminal apparatus 100 according to the embodiment of the present disclosure. Specifically, FIG. 14 illustrates an exemplary spectacular image output on the display in S210 of FIG. 8 and exemplary operation assist information output in superimposition on the spectacular image on the display in S211. Referring to FIG. 14, the virtual game space 10 is captured in the direction leading to the face object of the character C5 by the virtual camera VC4 newly selected. Thus, because, in order from the left end of the angle of view of the virtual camera VC4, the character C5, the structure object O4, and the structure object O1 are arranged in the virtual game space 10, the spectacular image includes the character C5, the structure object O4, and the structure object O1 in order from its left end. Note that, in the virtual game space 10, the character C3 and the character C4 are included in the angle of view of the virtual camera VC4. However, the character C3 and the character C4 are hidden on the back side of the structure object O4 located closer to the virtual camera VC4, resulting in non-display.

Referring to FIG. 14, operation assist information 15 and operation assist information 16 are output in superimposition on the spectacular image. The operation assist information 15 that is a left arrow in shape, is output together with the letter “C2”. That is, the operation assist information 15 indicates that, although the character C2 is not included in the angle of view of the virtual camera VC4 because of its current orientation, if the orientation of the virtual camera VC4 is adjusted to the left, the character C2 is included in the angle of view. The operation assist information 16 that is a right arrow in shape, is output together with the letter “C1”. That is, the operation assist information 16 indicates that, although the character C1 is not included in the angle of view of the virtual camera VC4 because of its current orientation, if the orientation of the virtual camera VC4 is adjusted to the right, the character C1 is included in the angle of view. Thus, for example, when the spectator user wants to watch the character C1 or C2, the spectator user can be assisted in changing the orientation of the virtual camera VC4.

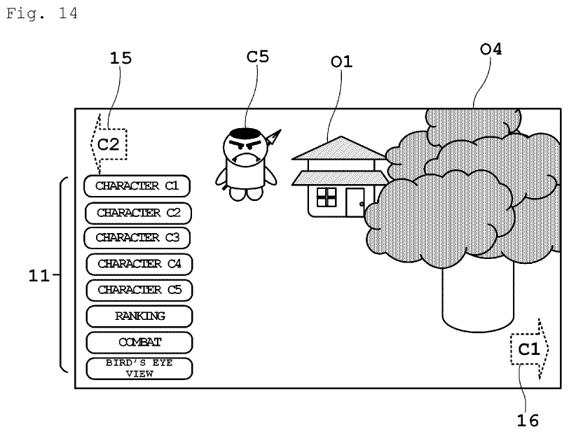

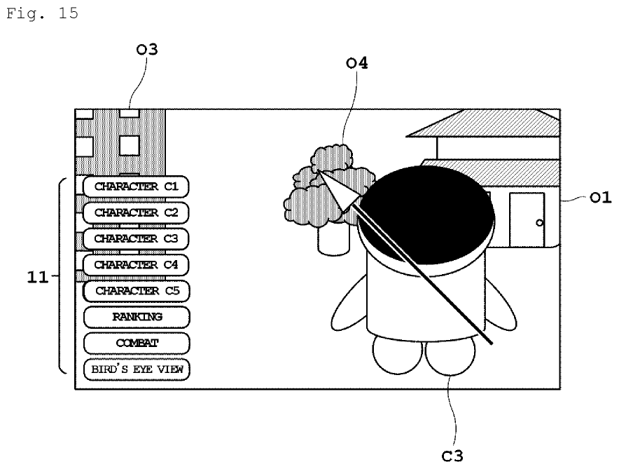

FIG. 15 illustrates an exemplary image output on the terminal apparatus 100 according to the embodiment of the present disclosure. Specifically, FIG. 15 illustrates an exemplary spectacular image output on the display in S302, S305, or S312 of FIG. 8A. Referring to FIG. 15, the captured image of a play scene of the character (character C3) selected due to an instruction input to a particular character icon or the ranking icon from the spectator user is output as a spectacular image. Note that the virtual camera that captures a play scene of the character C3 is omitted, for example, in FIG. 9 conceptually illustrating the virtual game space 10.

The spectacular image of FIG. 15 includes the back image of the character C3 located substantially at the center and the structure objects O3, O4, and 1 included in the angle of view of the virtual camera for the character C3. The spectacular image includes the operation assist information 11 for the spectator user to make a switch to another virtual camera.

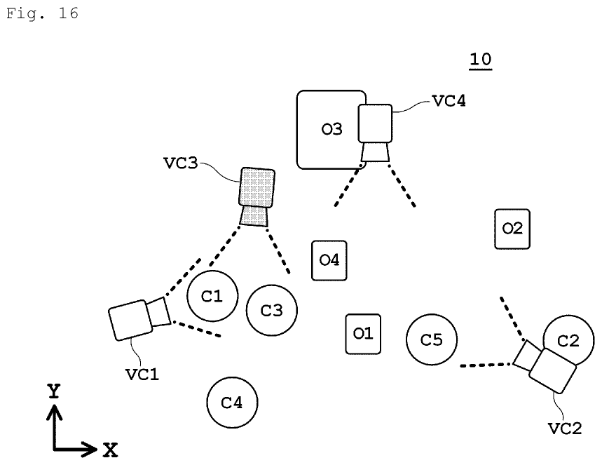

FIG. 16 conceptually illustrates the virtual game space 10 for the virtual game according to the embodiment of the present disclosure. Specifically, FIG. 16 illustrates the virtual game space 10 after a virtual camera is newly selected in S308 of FIG. 8B. Note that, although the virtual game space 10 in FIG. 16 is given as a two-dimensional space for convenience of description, the virtual game space 10 is formed as a three-dimensional space.

Referring to FIG. 16, similarly to, for example, FIG. 9, on the basis of the arrangement coordinates information on each virtual camera stored in the virtual camera table and the arrangement coordinates information on each character stored in the character table, each character and each virtual camera are arranged in the virtual game space 10. In this state, the virtual camera VC3 remains selected due to acceptance of an instruction input for switching the virtual camera that captures a spectacular image from the virtual camera VC1 to the virtual camera capturing a combat scene. Specifically, the characters C1, C3, and C4 are arranged in the virtual game space 10, and the virtual camera VC3 located in the area highest in character density remains selected.

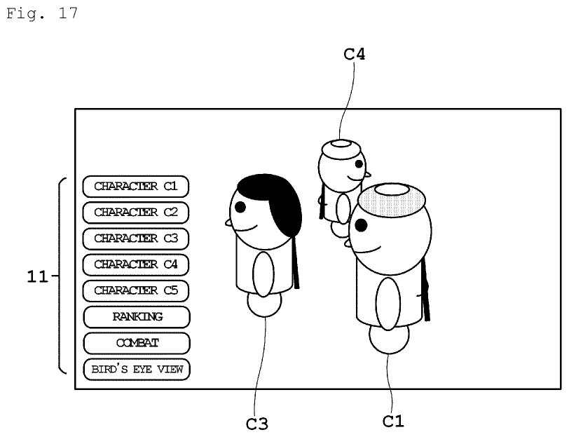

FIG. 17 illustrates an exemplary image output on the terminal apparatus 100 according to the embodiment of the present disclosure. Specifically, FIG. 17 illustrates an exemplary spectacular image output on the display in S308 of FIG. 8A. Referring to FIG. 17, the image captured by the virtual camera in the area in which an event remains performed (e.g., a combat scene) is output as a spectacular image. Therefore, in the example of FIG. 17, a larger number of characters are included in the spectacular image, so that a more realistic image can be provided to the spectator user. The spectacular image includes the operation assist information 11 for the spectator user to make a switch to another virtual camera.

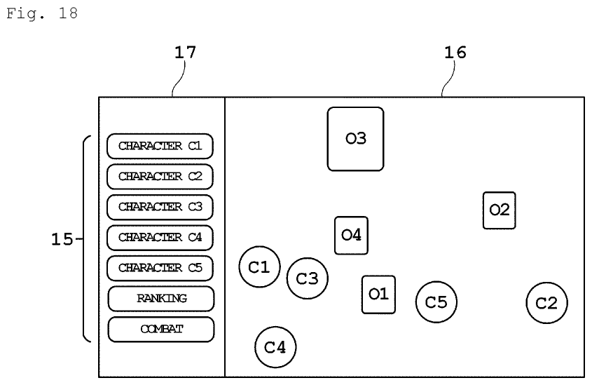

FIG. 18 illustrates an exemplary image output on the terminal apparatus 100 according to the embodiment of the present disclosure. Specifically, FIG. 18 illustrates an exemplary spectacular image output on the display in S310 of FIG. 8A. Referring to FIG. 18, the bird's eye view image of the virtual game space 10 captured by the virtual camera arranged above the virtual game space 10, is output in a bird's-eye-view image display area 16. That is, with reference to the bird's eye view image, the spectator user can easily grasp the arrangement relationship between the characters and the virtual objects in the virtual game space 10. Referring to FIG. 18, the operation assist information 15 is output in an operation-assist-information display area 17. Reference to the bird's eye view image in the bird's-eye-view image display area 16 adjacent to the operation-assist-information display area 17 facilitates selection of a virtual camera through the operation assist information 15.

According to the present embodiment, provided can be a processing apparatus, a program, and a method that enable provision of a more highly elaborate spectacular screen to a spectator.

Any processing and the corresponding procedure thereto in the present specification are not limited to the explicit manner in the embodiment and thus can be achieved by software, hardware, or a combination thereof. Specifically, any processing and the corresponding procedure thereto in the present specification are achieved by implementation of logic corresponding to the processing into a medium, such as an integrated circuit, a volatile memory, a nonvolatile memory, a magnetic disk, or an optical storage. Any processing and the corresponding procedure thereto in the present specification can be performed by various types of computers including a terminal apparatus and a server apparatus, with the processing/procedure implemented as a computer program.

Even in a case where any processing and the corresponding procedure thereto in the present specification are performed by a single apparatus, a single piece of software, a single component, or a single module, such processing or the corresponding procedure thereto can be performed by a plurality of apparatuses, a plurality of pieces of software, a plurality of components, and/or a plurality of modules. Even in a case where any type of information in the present specification is stored in a single memory or a single storage unit, such a type of information can be stored, in a distribution manner, in a plurality of memories in a single apparatus or in a plurality of memories arranged, in a distribution manner, in a plurality of apparatuses. Furthermore, the elements of software and hardware in the present specification can be integrated into a smaller number of constituent elements or can be divided into a larger number of constituent elements, for achievement.

The processing apparatus, program, and method being thus described, it will be apparent that the same may be varied in many ways. Such variations are not to be regarded as a departure from the spirit and scope of the invention, and all such modifications as would be apparent to one of ordinary skill in the art are intended to be included within the scope of the following claims.

What is claimed is:

1. A processing apparatus comprising:
an input interface configured to accept, in a virtual game that a participant user controls in progress, an instruction input from a spectator user different from the participant user, for selection of at least one virtual camera from a plurality of virtual cameras arranged in a virtual game space in which the virtual game progresses, the plurality of virtual cameras including first and second virtual cameras;
an output interface configured to output, to the spectator user, a spectacular image of the virtual game space virtually captured by at least one virtual camera of the plurality of virtual cameras;
a memory configured to store computer readable instructions, an arrangement position of each of the plurality of virtual cameras in the virtual game space, and the spectacular image of the virtual game space; and
a processor configured to execute the computer readable instructions so as to:
select the first virtual camera in response to a first input as the instruction input and output a first spectacular image of the virtual game space virtually captured by the first virtual camera in accordance with the selection of the first virtual camera;
select the second virtual camera in response to a second input as the instruction input while outputting the first spectacular image via the output interface; and
output a second spectacular image of the virtual game space virtually captured by the second virtual camera via the output interface in accordance with the selection of the second virtual camera, instead of the first spectacular image.

2. The processing apparatus according to claim 1,
wherein the processor is further configured to change a parameter for one of the plurality of virtual cameras that captures a spectacular image of the virtual game space based on a parameter input as the instruction input.

3. The processing apparatus according to claim 2,
wherein the parameter relates to an orientation or zooming of the one of the plurality virtual cameras.

4. The processing apparatus according to claim 2,
wherein the output interface is further configured to output operation assist information that assists change of the parameter.

5. The processing apparatus according to claim 1,
wherein the output interface is further configured to output selection assist information that assists the spectator user to select the second virtual camera.

6. The processing apparatus according to claim 5,
wherein the selection assist information includes a thumbnail image virtually captured by a virtual camera, different from the first virtual camera, of the plurality of virtual cameras.

7. The processing apparatus according to claim 6,
wherein the processor is configured to output the thumbnail image via the output interface in superimposition on the first spectacular image.

8. The processing apparatus according to claim 1,
wherein a plurality of virtual objects is arranged in the virtual game space, and the plurality of virtual objects includes a first virtual object,
the processor is configured to select the first virtual object based on a selection input as the instruction input from the spectator user via the input interface, and
the processor is configured to select the second virtual camera based on an attribute of the first virtual object.

9. The processing apparatus according to claim 8,
wherein the attribute corresponds to at least either an arrangement position of the first virtual object or an orientation of the first virtual object in the virtual game space.

10. A computer program product embodying computer readable instructions stored on a non-transitory computer-readable storage medium for causing a computer to execute a process by a processor so as to perform the steps of:
accepting, in a virtual game that a participant user controls in progress, an instruction input from a spectator user different from the participant user, for selection of at least one virtual camera from a plurality of virtual cameras arranged in a virtual game space in which the virtual game progresses, the plurality of virtual cameras including first and second virtual cameras;
outputting, to the spectator user, a spectacular image of the virtual game space virtually captured by at least one virtual camera of the plurality of virtual cameras;
selecting the first virtual camera in response to a first input as the instruction input and outputting a first spectacular image of the virtual game space virtually captured by the first virtual camera in accordance with the selection of the first virtual camera;
selecting the second virtual camera in response to a second input as the instruction input while outputting the first spectacular image; and
outputting a second spectacular image of the virtual game space virtually captured by the second virtual camera in accordance with the selection of the second virtual camera, instead of the first spectacular image.

11. The computer program product according to claim 10,
wherein the processor is further configured to change a parameter for one of the plurality of virtual cameras that captures a spectacular image of the virtual game space based on a parameter input as the instruction input.

12. The computer program product according to claim 11,
wherein the parameter relates to an orientation or zooming of the one of the plurality virtual cameras, and
the processor is further configured to output operation assist information that assists change of the parameter to the spectator user.

13. The computer program product according to claim 10,
wherein the processor is further configured to output selection assist information that assists the spectator user to select the second virtual camera, and
the selection assist information includes a thumbnail image virtually captured by a virtual camera, different from the first virtual camera, of the plurality of virtual cameras.

14. The computer program product according to claim 13,
wherein the processor is configured to output the thumbnail image in superimposition on the first spectacular image.

15. The computer program product according to claim 10,
wherein a plurality of virtual objects is arranged in the virtual game space, and the plurality of virtual objects includes a first virtual object,
the processor is configured to select the first virtual object based on a selection input as the instruction input from the spectator user,
the processor is configured to select the second virtual camera based on an attribute of the first virtual object, and
the attribute corresponds to at least either an arrangement position of the first virtual object or an orientation of the first virtual object in the virtual game space.

16. A method for causing a processor to execute a process, the method comprising executing on the processor the steps of:
accepting, in a virtual game that a participant user controls in progress, an instruction input from a spectator user different from the participant user, for selection of at least one virtual camera from a plurality of virtual cameras arranged in a virtual game space in which the virtual game progresses, the plurality of virtual cameras including first and second virtual cameras;
outputting, to the spectator user, a spectacular image of the virtual game space virtually captured by at least one virtual camera of the plurality of virtual cameras;
selecting the first virtual camera in response to a first input as the instruction input and outputting a first spectacular image of the virtual game space virtually captured by the first virtual camera in accordance with the selection of the first virtual camera;
selecting the second virtual camera in response to a second input as the instruction input while outputting the first spectacular image; and
outputting a second spectacular image of the virtual game space virtually captured by the second virtual camera in accordance with the selection of the second virtual camera, instead of the first spectacular image.

17. The method according to claim 16,
wherein the processor is further configured to change a parameter for one of the plurality of virtual cameras that captures a spectacular image of the virtual game space based on a parameter input as the instruction input,
the parameter relates to an orientation or zooming of the one of the plurality virtual cameras, and
the processor is further configured to output operation assist information that assists change of the parameter to the spectator user.

18. The method according to claim 16,
wherein the processor is further configured to output selection assist information that assists the spectator user to select the second virtual camera, and
the selection assist information includes a thumbnail image virtually captured by a virtual camera, different from the first virtual camera, of the plurality of virtual cameras.

19. The method according to claim 18,
wherein the processor is configured to output the thumbnail image in superimposition on the first spectacular image.

20. The method according to claim 16,
wherein a plurality of virtual objects is arranged in the virtual game space, and the plurality of virtual objects includes a first virtual object,
the processor is configured to select the first virtual object based on a selection input as the instruction input from the spectator user,
the processor is configured to select the second virtual camera based on an attribute of the first virtual object, and
the attribute corresponds to at least either an arrangement position of the first virtual object or an orientation of the first virtual object in the virtual game space.
